(19) United States
(12) Patent Application Publication
(10) Pub. No.: US 2023/0415565 A1
(43) Pub. Date: Dec. 28, 2023

(54) COOLING MODULE FOR AN ELECTRIC OR HYBRID MOTOR VEHICLE, HAVING A TANGENTIAL-FLOW TURBOMACHINE

(71) Applicant: VALEO SYSTEMES THERMIQUES, La Verriere (FR)

(72) Inventors: Amrid MAMMERI, La Verriere (FR); Kamel AZZOUZ, La Verriere (FR); Sebastien GARNIER, La Verriere (FR); Issiaka TRAORE, La Verriere (FR)

(73) Assignee: VALEO SYSTEMES THERMIQUES, La Verriere (FR)

(21) Appl. No.: 18/251,464

(22) PCT Filed: Sep. 30, 2021
(86) PCT No.: PCT/EP2021/076988

§ 371 Date: May 2, 2023

(30) Foreign Application Priority Data
Nov. 4, 2020 (FR) 2011330

(51) Int. Cl. B60K 11/08

(52) U.S. Cl. CPC B60K 11/085

(57) ABSTRACT

The invention relates to a cooling module including: a fairing inside which at least one heat exchanger is placed; a collector housing configured to receive a tangential turbomachine including a volute defining an outlet, the collector housing having a guide wall having a first opening and a first shut-off device movable between an open position and a closed position. The collector housing includes an additional wall opposite the guide wall and extending a downstream edge of the outlet. The additional wall includes a second opening and a second shut-off device movable between an open position and a closed position.

### TECHNICAL FIELD

The invention relates to a cooling module for an electric or hybrid motor vehicle, having a tangential-flow turbomachine.

### BACKGROUND OF THE INVENTION

A cooling module (or heat exchange module) of a motor vehicle conventionally comprises at least one heat exchanger and a ventilation device which is designed to generate an air stream passing through the at least one heat exchanger. This ventilation device is for example in the form of a tangential-flow turbomachine. It thus makes it possible, for example, to generate an air stream in contact with the heat exchanger, when the vehicle is stationary or running at low speed.

Furthermore, when running, the speed of the vehicle can be sufficient to create the air stream without assistance from the tangential-flow turbomachine. However, the presence of the tangential-flow turbomachine in the air stream can obstruct the latter and greatly increase the pressure drops, this impairing the good operation of the heat exchangers and the aerodynamics of the motor vehicle. In this regard, the cooling module can comprise at least one opening in addition to the air outlet of the tangential-flow turbomachine, and at least one flap per opening. This flap is generally able to pivot between an opening position and a closure position of said opening. Thus, when the vehicle is running and has reached a sufficient speed, this opening makes it possible to allow the air stream to pass through and to bypass the tangential-flow turbomachine.

Moreover, this cooling module can comprise an additional wall arranged for example at the air outlet of the tangential-flow turbomachine in order to limit the divergences of the air stream when the latter is discharged through said outlet. This additional wall makes it possible, for example, to orient the air stream in a specific direction.

However, such an additional wall can potentially obstruct the air stream when the latter is passing through the opening that supplements the air outlet of the tangential-flow turbomachine, and this can lead to non-negligible and undesired pressure drops.

### SUMMARY OF THE INVENTION

An aim of the invention is to propose a cooling module for an electric motor vehicle that does not have at least some of the above-mentioned drawbacks.

To that end, the subject of the invention is a cooling module for a motor vehicle with an electric motor or hybrid engine, the cooling module being intended to have an air stream passing through it and comprising a fairing forming an internal duct in a longitudinal direction of the cooling module, the internal duct extending between an upstream end and a downstream end which are opposite to one another and inside which at least one heat exchanger intended to have the air stream passing through it is disposed, the cooling module also comprising a collector housing disposed downstream of the fairing in the longitudinal direction, said collector housing being configured to receive a tangential-flow turbomachine which is itself configured to generate the air stream, the tangential-flow turbomachine comprising a volute which at least partially delimits an outlet for the air stream, the collector housing comprising, disposed facing the downstream end of the fairing, a guide wall for guiding the air stream to the outlet, said guide wall comprising an upstream edge making it possible to delimit the outlet for the air stream in a complementary manner to the volute, said guide wall comprising at least one first opening and at least one first shut-off device which is movable between an opening position and a closure position of said at least one first opening, the cooling module being characterized in that the collector housing comprises an additional wall disposed facing the guide wall, the additional wall extending a downstream edge of the outlet, said downstream edge being opposite to the upstream edge, and in that the additional wall comprises at least one second opening and at least one second shut-off device which is movable between an opening position and a closure position of said second opening.

Such a cooling module allows better guidance of the air stream when the latter is generated by the tangential-flow turbomachine and discharged through the outlet of the cooling module without, however, disrupting the flow of the air stream when the latter is generated by the motor vehicle moving at high speed in such a way as to circulate through the first opening or openings in the guide wall and the second opening or openings in the additional wall. Moreover, the additional wall can allow a reduction in the energy consumption of the tangential-flow turbomachine, thus making the cooling module more efficient.

The invention can further comprise one or more of the following aspects taken alone or in combination:
the second shut-off device comprises at least one movable valve mounted so as to be able to pivot between an opening position and a closure position;
the at least one movable valve comprises a seal disposed at its edges which are intended to come into contact with the additional wall;
the edge or edges of the at least one second opening which are intended to come into contact with the second shut-off device of the additional wall comprise at least one seal;
the additional wall has a width smaller than or equal to a width of the collector housing of the cooling module;
a plane extending between a free end edge of the additional wall and a downstream end edge of the collector housing is parallel to the longitudinal axis of the cooling module;
the additional wall comprises two lateral extensions which meet the guide wall in such a way as to form an extension duct of the outlet of the collector housing;
the additional wall is an added-on part cooperating with the downstream edge of the outlet of the collector housing;
the additional wall is integral with the collector housing;
the additional wall comprises a multiplicity of second openings arranged in a matrix;
each second opening comprises a movable valve dedicated thereto; and
only gravity brings the second shut-off device to, and holds it in, its closure position.

### BRIEF DESCRIPTION OF DRAWINGS

Further features and advantages of the present invention will become more clearly apparent on reading the following description, which is provided by way of non-limiting illustration, and from the appended drawings, in which:

FIG. 1 shows a schematic depiction of the front of a motor vehicle in side view;

FIG. 2 shows a schematic depiction in perspective and in partial section of the front of a motor vehicle and of a cooling module;

FIG. 3 shows a view in section of the cooling module in FIG. 2 according to a first operating mode; and

FIG. 4 is similar to FIG. 3 and depicts the cooling module according to a second operating mode.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Individual features of different embodiments can also be combined and/or interchanged to provide other embodiments.

In the present description, certain elements or parameters can be indexed, such as, for example, first element or second element and also first parameter and second parameter or else first criterion and second criterion, etc. In this case, this is simple indexing to differentiate and designate elements or parameters or criteria that are similar but not identical. This indexing does not imply priority being given to one element, parameter or criterion over another and such designations can be interchanged easily without departing from the scope of the present description. Neither does this indexing imply any chronological order for example in assessing any given criterion.

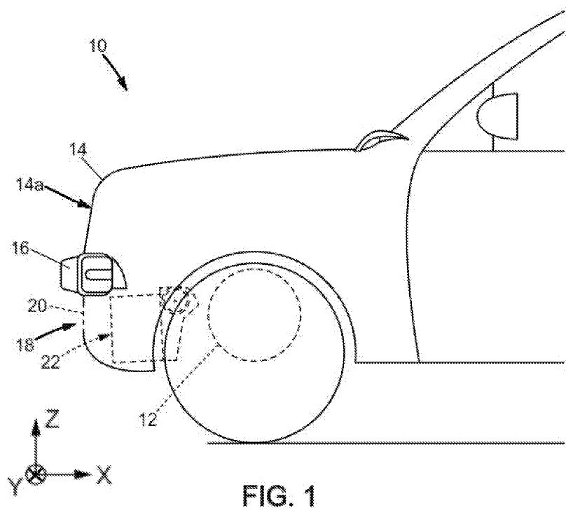

In FIGS. 1 to 4, a trihedron XYZ is depicted in order to define the orientation of the various elements relative to one another. A first direction, denoted X, corresponds to a longitudinal direction of the vehicle. It also corresponds to a direction opposite to the direction of forward travel of the vehicle. A second direction, denoted Y, is a lateral or transverse direction. Finally, a third direction, denoted Z, is vertical. The directions X, Y, Z are orthogonal in pairs.

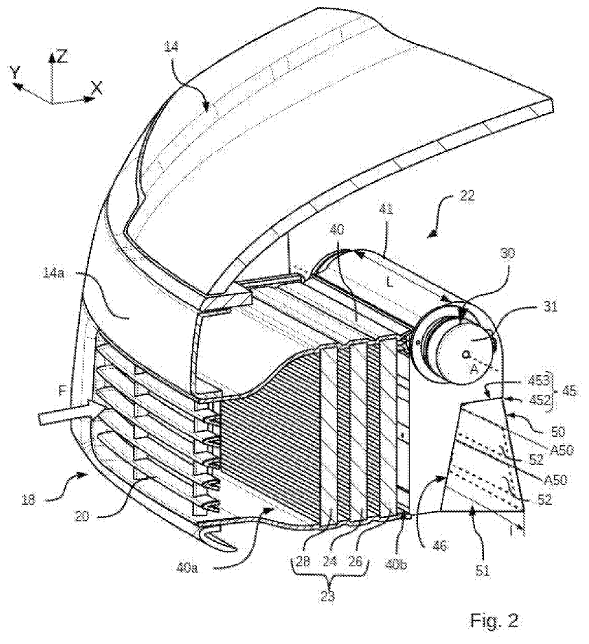

In FIGS. 1 and 2, the cooling module according to the present invention is illustrated in a functional position, that is to say when it is disposed within a motor vehicle.

FIG. 1 schematically illustrates the front part of an electric or hybrid motor vehicle 10, which can comprise an electric motor or hybrid engine 12. The vehicle 10 notably comprises a body 14 and a bumper 16 which are borne by a chassis (not depicted) of the motor vehicle 10. The body 14 defines a cooling opening 18, that is, an opening through the body 14. In this case, there is only one cooling opening 18. This cooling opening 18 is preferably in the lower part of the front face 14a of the body 14. In the example illustrated, the cooling opening 18 is situated below the bumper 16. A grille 20 can be disposed in the cooling opening 18 to prevent projectiles from being able to pass through the cooling opening 18. A cooling module 22 is disposed facing the cooling opening 18. The grille 20 notably makes it possible to protect this cooling module 22.

As shown in FIGS. 2, 3 and 4, the cooling module 22 is intended to have an air stream F passing through it parallel to the direction X, and going from the front toward the rear of the vehicle 10. This direction X corresponds more particularly to the longitudinal axis of the cooling module 22. In the present application, an element which is disposed further toward the front or toward the rear than another element is referred to as “upstream” or “downstream”, respectively, in the longitudinal direction X. The front corresponds to the front of the motor vehicle 10 in the mounted state, or to the face of the cooling module 22 through which the air stream F is intended to enter the cooling module 22. The rear, for its part, corresponds to the rear of the motor vehicle or to the face of the cooling module 22 through which the air stream F is intended to leave the cooling module 22.

The cooling module 22 essentially comprises a fairing 40 forming an internal duct between an upstream end 40a and a downstream end 40b, which are opposite to one another. At least one heat exchanger 24, 26, 28 is disposed inside said fairing 40. This internal duct is preferably oriented parallel to the direction X such that the upstream end 40a is oriented toward the front of the vehicle 10, opposite the cooling opening 18, and such that the downstream end is oriented toward the rear of the vehicle 10. In the figures, the cooling module 22 comprises three heat exchangers 24, 26, 28 grouped together within a set of heat exchangers 23. However, it could comprise more or fewer depending on the desired configuration.

A first heat exchanger 24 can for example be configured to release heat energy from the air stream F. This first heat exchanger 24 can more particularly be a condenser connected to a cooling circuit (not depicted), for example in order to cool the batteries of the vehicle 10. This cooling circuit can for example be an air conditioning circuit able to cool the batteries and an internal air stream intended for the motor vehicle interior.

A second heat exchanger 26 can also be configured to release heat energy into the air stream F. This second heat exchanger 26 can more particularly be a radiator connected to a thermal management circuit (not depicted) for electric elements such as the electric motor or hybrid engine 12.

Since the first heat exchanger 24 is generally a condenser of an air conditioning circuit, the latter needs the air stream F to be as “fresh” as possible in air conditioning mode. For this, the second heat exchanger 26 is preferably disposed downstream of the first heat exchanger 24 in the direction of circulation of the air stream F. It is nevertheless entirely conceivable for the second heat exchanger 26 to be disposed upstream of the first heat exchanger 24.

The third heat exchanger 28 can for its part also be configured to release heat energy into the air stream. This third heat exchanger 28 can more particularly be a radiator connected to a thermal management circuit (not depicted), which can be separate from the one connected to the second heat exchanger 26, for electric elements such as the power electronics. It is also entirely conceivable for the second 26 and the third 28 heat exchangers to be connected to a single thermal management circuit, for example connected in parallel with one another.

Still according to the example illustrated in FIGS. 2, 3 and 4, the second heat exchanger 26 is disposed downstream of the first heat exchanger 24 while the third heat exchanger 28 is disposed upstream of the first heat exchanger 24. Other configurations can nevertheless be envisaged, such as the second 26 and third 28 heat exchangers both disposed downstream or upstream of the first heat exchanger 24.

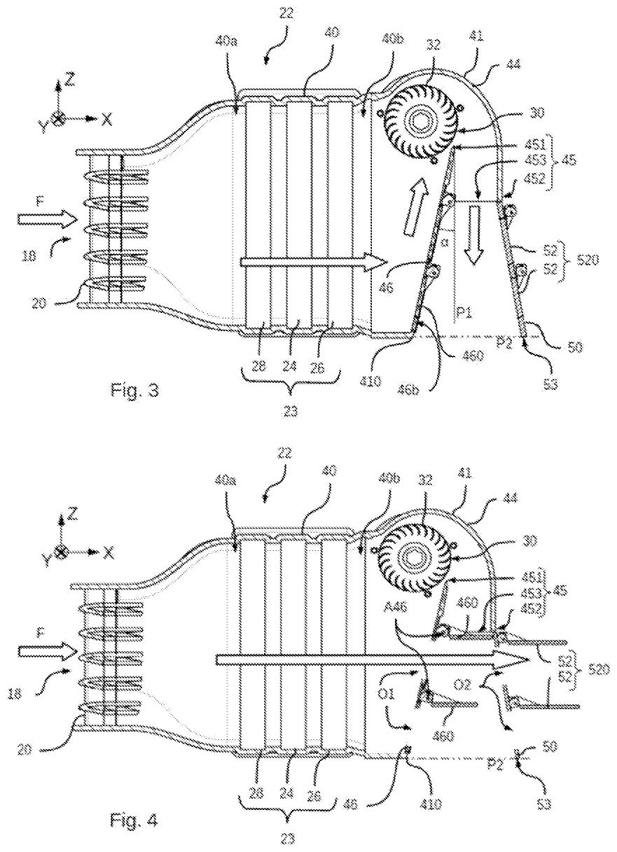

In the embodiment illustrated, each of the heat exchangers 24, 26, 28 has a parallelepipedal overall shape that is determined by a length, a thickness and a height. The length extends along the direction Y, the thickness along the direction X and the height in the direction Z. The heat exchangers 24, 26, 28 then extend along planes parallel to a first plane P1 which is perpendicular to the longitudinal direction X of the cooling module 22. The first plane P1 is therefore parallel to the vertical direction Z and the lateral direction Y, and it is notably depicted by a solid line in FIG. 3.

The cooling module 22 also comprises a collector housing 41 disposed downstream of the fairing 40 and of the set 23 of heat exchangers 24, 26, 28 in the longitudinal direction X of the cooling module 22. More specifically, the collector housing 41 is disposed at the downstream end 40b of the fairing 40, and it is therefore aligned with the fairing 40 along the longitudinal axis X of the cooling module 22. This collector housing 41 comprises an outlet 45 for the air stream F. The collector housing 41 makes it possible to recover the air stream F passing through the set of heat exchangers 23 and to orient this air stream F toward the outlet 45, and this is notably illustrated by the arrows depicting the air stream F in FIG. 3. The collector housing 41 can be integral with the fairing 40 or it can be an added-on part fixed at the downstream end 40b of said fairing 40.

The cooling module 22, more specifically the collector housing 41, also comprises at least one tangential-flow fan, also known as a tangential-flow turbomachine 30, which is configured so as to generate the air stream F passing through the set of heat exchangers 23. The tangential-flow turbomachine 30 comprises a rotor or turbine 32 (or tangential blower-wheel). The turbine 32 has a substantially cylindrical shape. The turbine 32 advantageously has several stages of blades (or vanes), which are visible in FIG. 3. The turbine 32 is mounted so as to be able to rotate about an axis of rotation A, which is for example parallel to the Y direction. The diameter of the turbine 32 is for example between 35 mm and 200 mm so as to limit its size. The tangential-flow turbomachine 30 is thus compact.

The tangential-flow turbomachine 30 can also comprise a motor 31 (visible in FIG. 2) configured to set the turbine 32 in rotation. The motor 31 is for example suitable for rotating the turbine 32 at a speed of between 200 rpm and 14,000 rpm. This notably makes it possible to limit the noise generated by the tangential-flow turbomachine 30.

The tangential-flow turbomachine 30 is disposed in the collector housing 41. The tangential-flow turbomachine 30 is then configured to draw in air in order to generate the air stream F passing through the set of heat exchangers 23. The tangential-flow turbomachine 30 more specifically comprises a volute 44, which is formed by the collector housing 41 and at the center of which the turbine 32 is disposed. The volute 44 at least partially delimits the outlet 45 for the air stream F. In other words, the evacuation of air from the volute 44 corresponds to the output 45 of the air stream F from the collector housing 41.

In the example illustrated in all of FIGS. 2 to 4, the tangential-flow turbomachine 30 is in a high position, notably in the upper third of the collector housing 41, preferably in the upper quarter of the collector housing 41. This notably makes it possible to protect the tangential-flow turbomachine 30 in the event of submersion, and/or to limit the space taken up by the cooling module 22 in its lower part. In this scenario, the outlet 45 for the air stream F is preferably oriented toward the lower part of the cooling module 22.

It is nevertheless conceivable for the tangential-flow turbomachine 30 to be in a low position, notably in the lower third of the collector housing 41. This would make it possible to limit the space taken up by the cooling module 22 in its upper part. In this scenario, the outlet 45 for the air stream will preferably be oriented toward the upper part of the cooling module 22. Alternatively, the tangential-flow turbomachine 30 can be in a median position, notably in the median third of the height of the first collector housing 41, for example for reasons of integration of the cooling module 22 into its surroundings. These alternatives are not illustrated.

Here, upper and lower mean an orientation in the direction Z. An element referred to as upper will be closer to the roof of the vehicle 10 and an element referred to as lower will be closer to the ground.

In order to guide the air from the set of heat exchangers 23 to the outlet 45, the collector housing 41 comprises, disposed facing the downstream end 40b of the fairing 40, a guide wall 46 for guiding the air stream F to the outlet 45. The guide wall 46 more particularly comprises an upstream edge 451 making it possible to delimit the outlet 45 for the air stream F in a complementary manner to the volute 44. Here, upstream edge 451 means the edge of the outlet 45 closest to the downstream end 40b of the fairing 40.

The guide wall 46 is inclined with respect to the first plane P1 perpendicular to the longitudinal direction X of the cooling module 22, and can notably form an acute angle α with this first plane P1, as illustrated notably in FIG. 3. The angle α is for example between 10° and 23°. The inclination of the guide wall 46 allows better circulation of the air stream F within the collector housing 41 and limits pressure drops.

The guide wall 46 comprises at least one first opening O1 (visible in FIG. 4) and at least one first shut-off device 460 which is movable between an opening position (illustrated in FIG. 4) and a closure position (illustrated in FIG. 3) of said at least one first opening O1. In other words, the guide wall 46 is perforated. The at least one first shut-off device 460 can notably be in the form of a pivoting flap mounted on an external face 46b of the guide wall 46. The external face 46b denotes the face of the guide wall 46 located facing the outlet 45. Thus the at least one first shut-off device 460 makes it possible to open or close the at least one first opening O1.

The guide wall 46 can comprise one or more first openings O1. Hence, the at least one first shut-off device 460 can comprise one or more flaps. There are notably as many flaps mounted on the external face 46b of the guide wall 46 as there are first openings O1. According to one embodiment of the cooling module 22 illustrated in FIGS. 3 and 4, the guide wall 46 comprises two first openings O1 and two flaps.

The at least one first shut-off device 460 is for example mounted so as to be able to pivot about a pivot axis A46 (indicated in FIG. 4) which extends horizontally in the state mounted within the motor vehicle 10. The pivot axis A46 is therefore substantially parallel to the axis of rotation A of the tangential-flow turbomachine 30, and it is therefore perpendicular to the longitudinal direction X of the cooling module 22. The at least one first shut-off device 460 can be in the form of an end-hung flap, as illustrated in FIGS. 3 and 4, but other types of flaps can be envisaged, such as butterfly flaps.

The at least one first shut-off device 460 can be “free” or “passive” in the sense that only gravity brings the at least one first shut-off device 460 to, and holds it in, its closure position. In other words, the cooling module 22 does not comprise any mechanical components, or any control devices, configured to actively control the opening and/or the closing of the at least one flap 460.

According to an alternative embodiment of the at least one first shut-off device 460, the latter can be elastically urged toward its closure position. For example, one or more springs can be functionally interposed between the guide wall 46 and the pivoting flap or flaps of the at least one first shut-off device 460, urging the latter to adopt a closure position in which it is aligned with the surface 46b of the guide wall 46, as illustrated in FIG. 3.

When the pressure of the air stream F against the pivoting flap or flaps of the at least one first shut-off device 460 is greater than a threshold value, the at least one first shut-off device 460 pivots from its closure position to its opening position, thus allowing the air stream F to circulate through the at least one first opening O1 in the guide wall 46. In this case, the air stream F no longer passes through the volute 44 of the collector housing 41, the air stream F “bypasses” the tangential-flow turbomachine 30 by passing directly through the at least one first opening O1 in the guide wall 46, this furthermore making it possible to reduce the pressure drops.

According to another non-illustrated embodiment of the at least one first shut-off device 460, the latter is equipped with a control system making it possible to control the pivoting of the at least one first shut-off device 460 between its opening position and its closure position.

The edges of the at least one first opening O1 in the guide wall 46 which are intended to come into contact with the edge or edges of the at least one first shut-off device 460 can comprise one or more seals. The seal or seals can allow the shock of the impact of the edges of the at least one first shut-off device 460 on the edge or edges of the at least one first opening O1 to be absorbed when said first shut-off device 460 reaches it closure position. This or these seals can be produced by overmolding of the edge or edges of the at least one first opening O1 in the guide wall 46. Alternatively, the seal or seals can be added-on parts.

Moreover, the edge or edges of the at least one first shut-off device 460 can also comprise at least one seal. This at least one seal can be produced by overmolding or it can be an added-on part.

The collector housing 41 also comprises an additional wall 50 disposed facing the guide wall 46. The additional wall 50 extends a downstream edge 452 of the outlet 45, this downstream edge 452 is opposite to the upstream edge 451. Here, downstream edge 452 denotes the edge of the outlet 45 furthest away from the downstream end 40b of the fairing 40. The upstream edge 451 and the downstream edge 452 are connected to one another by lateral edges 453 in such a way as to delimit the contours of the outlet 45 of the collector housing 41, as illustrated more particularly in FIGS. 2 and 3.

The additional wall 50 is for example a planar and rigid plate, which makes it possible to limit the divergences of the air stream F intended to be discharged through the outlet 45. It can notably form an extension of the volute 44 of the collector housing 41. The additional wall 50 can be inclined slightly with respect to the vertical plane P1. The value of the angle of this inclination can be similar, or even identical, to the angle α in terms of absolute value, but the direction of the inclination of the additional wall 50 is inverted with respect to that of the guide wall 46, as illustrated for example in FIGS. 3 and 4. This then results in a funnel shape, which makes it possible to create a depression making it possible to facilitate the evacuation of the air stream F. The widest section of this funnel is oriented toward the lower part of the cooling module 22 and the narrowest section corresponds to the outlet 45.

An additional wall 50 furthermore makes it possible to limit the power required for the operation of the tangential-flow turbomachine 30. It also makes it possible to reduce the acoustic nuisance caused by the motor 31 and the circulation of the air stream F within the tangential-flow turbomachine 30.

According to one embodiment illustrated in FIG. 2, the additional wall 50 can comprise two lateral extensions 51, which meet the guide wall 46 in such a way as to form an extension duct of the outlet 45. Such an extension duct notably makes it possible to limit the divergences of the air stream F discharged through the outlet 45. This particular embodiment of the additional wall 50 also makes it possible to limit any vibrations generated by the operation of the tangential-flow turbomachine 30.

The additional wall 50 can notably be in the form of an added-on part cooperating with the downstream edge 452 of the outlet 45 of the collector housing 41, and this makes it possible to replace this additional wall 50 more easily if necessary. In this case, the additional wall 50 can for example be screwed, adhesively bonded or clipped to the downstream edge 452 of the outlet 45. It is also possible to conceive of an embodiment of the cooling module 22 in which the downstream end 452 of the outlet 45 and at least one portion of the additional wall 50 are magnetized so as to cooperate by magnetism.

In one variant, the additional wall 50 can be integral with the collector housing 41, and this variant makes it possible to dispense with a connecting means between the additional wall 50 and the collector housing 41 of the cooling module 22.

According to one embodiment illustrated in FIG. 2, the additional wall 50 has a width 1 smaller than or equal to, preferably equal to, a width L of the collector housing 41 of the cooling module 22. In other words, the lateral edges of the additional wall 50 do not go beyond either side of the lateral faces of the cooling module 22.

A similar reasoning applies for the extent of the additional wall 50 in the direction Y, which corresponds to the vertical direction in FIGS. 1 to 4. More particularly, the additional wall is dimensioned such that a plane P2 extending between a free end edge 53 of the additional wall 50 and a downstream end edge 410 of the collector housing 41 is parallel to the longitudinal axis X of the cooling module 22. The plane P2 is notably depicted in FIGS. 3 and 4. In these figures, the plane P2 is horizontal. The downstream end edge 410 is oriented facing the outlet 45 for the air stream F. This means that, as illustrated in FIGS. 3 and 4, if the outlet 45 is oriented toward the lower part of the cooling module 22, the downstream end edge 410 is a lower end edge of the collector housing 41. Conversely, if the outlet 45 is oriented toward the upper part of the cooling module 22, the downstream end edge 410 will be an upper end edge of the collector housing 41.

These dimensional restrictions of the additional wall 50 notably make it possible to limit the space taken up by the cooling module 22 within the motor vehicle 10.

The guide wall 50 comprises at least one second opening O2 (visible in FIG. 4) and at least one second shut-off device 520 which is movable between an opening position (illustrated in FIG. 4) and a closure position (illustrated in FIG. 3) of said second opening O2. The second shut-off device 520 can exhibit similarities to the at least one first shut-off device 460.

More particularly, the second shut-off device 520 can comprise at least one movable valve 52, which can be likened to a pivoting flap. The second shut-off device 520 is for example mounted so as to be able to pivot about a pivot axis A50 (indicated in FIG. 2) which extends horizontally in the state mounted within the motor vehicle 10. The pivot axis A50 is therefore substantially parallel to the axis of rotation A of the tangential-flow turbomachine 30 and to the pivot axes A46 of the at least one first shut-off device 460, and it is therefore perpendicular to the longitudinal direction X of the cooling module 22. The second shut-off device 520 can for its part be in the form of an end-hung flap, as illustrated in FIGS. 2 to 4, but other types of flaps can be envisaged, such as butterfly flaps.

The additional wall 50 can comprise a multiplicity of second openings O2 arranged in a matrix. Here, “arranged in a matrix” is understood to mean that the second openings O2 in the additional wall 50 are disposed in rows one beside the other in the direction Y and/or disposed in columns within the additional wall 50 in a direction perpendicular to the direction Y. The additional wall 50 can for example comprise as many second openings O2 as the guide wall 46 comprises first openings O1. Preferably, the second opening or openings O2 are arranged in such a way within the additional wall 50 that these second openings O2 are disposed in the extension of the first opening or openings O1 in the longitudinal direction X of the cooling module 22. If the additional wall 50 comprises a multiplicity of second openings O2, each opening O2 can comprise a movable valve 52 dedicated thereto. In the example illustrated in FIGS. 2 to 4, the additional wall 50 more particularly comprises two second openings O2 and two movable valves 52. By way of example, the number of second openings O2 and of movable valves 52 is between one and ten.

Moreover, the second shut-off device 520 can be “free” or “passive” in the sense that only gravity brings the second shut-off device 520 to, and holds it in, its closure position. In other words, the cooling module 22 does not comprise any mechanical components, or any control devices, configured to actively control the opening and/or the closing of the second shut-off device 520. The latter is therefore always subjected to gravity, but when the motor vehicle 10 is moving at a sufficiently high speed, the air stream F passing through the at least one first opening O1 in the guide wall 46 can exert a pressure on the second shut-off device 520 in such a way as to move the latter from its closure position to its opening position. Thus the air stream F is caused to pass through the at least one second opening O2 in the additional wall 50.

The at least one movable valve 52 can comprise a seal disposed at the edges which are intended to come into contact with the additional wall 50. This seal can allow the shock of the impact of the edges of the second shut-off device 520 on the edge or edges of the at least one second opening O2 in the additional wall 50 to be absorbed when said second shut-off device 520 reaches it closure position.

Likewise, the edge or edges of the at least one opening O2 which are intended to come into contact with the second shut-off device 520 of the additional wall 50 can comprise at least one seal.

This or these seals can be produced by overmolding of the edge or edges of the at least one second opening O2 in the additional wall 50. Alternatively, the seal or seals can be added-on parts.

The invention is not limited to the exemplary embodiments described with reference to the figures, and further embodiments will be clearly apparent to a person skilled in the art. In particular, the various examples can be combined, provided they are not contradictory.

1. A cooling module for an electric or hybrid motor vehicle, said cooling module being intended to have an air stream passing through it and comprising:
a fairing forming an internal duct in a longitudinal direction of the cooling module, the internal duct extending between an upstream end and a downstream end which are opposite to one another and inside which at least one heat exchanger intended to have the air stream passing through it is disposed;
a collector housing disposed downstream of the fairing in the longitudinal direction, said collector housing including a tangential-flow turbomachine configured to generate the air stream, said tangential-flow turbomachine including a volute which at least partially delimits an outlet for the air stream, the collector housing including, disposed facing the downstream end of the fairing, a guide wall adapted to guide the air stream to the outlet;
said guide wall including an upstream edge adapted to delimit the outlet for the air stream in a complementary manner to the volute, said guide wall including at least one first opening and at least one first shut-off device which is movable between an opening position and a closure position to respectively open and close said at least one first opening,
wherein the collector housing includes an additional wall disposed facing the guide wall, the additional wall extending a downstream edge of the outlet, said downstream edge being opposite to the upstream edge of the guide wall, and in that the additional wall comprises includes at least one second opening and at least one second shut-off device which is movable between an opening position and a closure position to respectively open and close said at least one second opening.

2. The cooling module as claimed in claim 1, wherein the at least one second shut-off device includes at least one movable valve mounted so as to be able to pivot between an opening position and a closure position.

3. The cooling module as claimed in claim 2, wherein the at least one movable valve comprises includes at least one valve seal disposed at its edges which are intended to come into contact with the additional wall in the closure position.

4. The cooling module as claimed in claim 1, wherein the or edges of the at least one second opening which are intended to come into contact with the at least one second shut-off device of the additional wall comprise include at least one opening seal.

5. The cooling module as claimed in claim 1, wherein plane extending between a free end edge of the additional wall and a downstream end edge of the collector housing is parallel to the longitudinal axis of the cooling module.

6. The cooling module as claimed in claim 1, wherein the additional wall comprises includes two lateral extensions which meet the guide wall in such a way as to form an extension duct of the outlet of the collector housing.

7. The cooling module as claimed in claim 1, wherein the additional wall is an added-on part adjacent to the downstream edge of the outlet of the collector housing.

8. The cooling module as claimed in claim 1, wherein the additional wall is integral with the collector housing.

9. The cooling module as claimed in claim 1, wherein the additional wall comprises includes a multiplicity of second openings arranged in a matrix, and each of the multiplicity of second openings comprises includes a movable valve dedicated thereto.

10. The cooling module as claimed in claim 1, wherein the at least one second shut-off device is configured to be brought to and held in the closure position by gravity.
